(19) United States
(12) Patent Application Publication
(10) Pub. No.: US 2006/0076934 A1
(43) Pub. Date: Apr. 13, 2006

(54) Control circuit for charging/discharging of secondary cell and a sensor node

(76) Inventors: Yuji Ogata, Hachioji (JP); Shunzo Yamashita, Musashino (JP); Takanori Shimura, Chiba (JP); Kiyoshi Aiki, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/072,490

(22) Filed: Mar. 7, 2005

(30) Foreign Application Priority Data
Sep. 29, 2004 (JP) 2004-283030

(51) Int. Cl. H02J 7/00

(52) U.S. Cl. 320/136

(57) ABSTRACT

In a sensor node SN driven by a secondary battery, a charge/discharge control circuit can be realized and an unnecessary circuit in the sensor node can be eliminated for its miniaturization. The charge/discharge control circuit and the sensor node have a comparator for monitoring a battery voltage, a control circuit for converting an output of the comparator into an interrupt signal, a micro controller for performing charge/discharge control only when detecting the interrupt signal, and a switch turned ON or OFF under control of the micro controller. When the battery voltage is not lower than a first predetermined voltage, the switch is turned OFF to thereby stop charging operation. When the battery voltage is not higher than a second predetermined voltage, the switch is turned OFF to stop discharging operation. A circuit necessary in a charge mode is provided in a charger side.

### CLAIM OF PRIORITY

The present application claims priority from Japanese application JP2004-283030 filed on Sep. 29, 2004, the contents of which is hereby incorporated by reference into this application.

### BACKGROUND OF THE INVENTION

The present invention relates to a charge/discharge control circuit for controlling charge/discharge of a secondary battery for use in a small sensing radio terminal (which will be referred to as a sensor node, hereinafter) and to such a sensor node, and more particular, to a charge/discharge control circuit which can minimize power consumption.

A sensor net in the present invention refers to a system in which a multiplicity of sensor nodes are arranged in an environment and respectively form a radio network to acquire various sorts of information. The sensor node, which has a sensor for acquiring, for example, temperature, humidity, pressure, etc. mounted therein, transmits acquired information to another sensor node or a base station by radio communication. The base station is connected with a server for storing the acquired information, a control center for monitoring information or the like via a communication network such as LAN. For example, a sensor node having a temperature sensor mounted therein can be installed in an office or a factory to acquire a distribution of room temperature and to use it for air conditioning control or the like. Further, when a pulse sensor is mounted in a sensor node to measure a person's pulse frequency, the health condition or the like of the person can be monitored even from a remote place.

In this way, a multiplicity of such sensor nodes are, in many cases, placed in an environment where a battery is used as a means for supplying power to each sensor node. For the purpose of increasing the convenience of the sensor net system, it is desirable to prolong the life of the battery and to reduce the battery exchange frequency and charging frequency. One way to prolong the battery life, is to activate the sensor node at intervals, that is, to provide intermittent operation thereto in such a manner that the power of circuit elements in the sensor node is turned OFF or the elements are put in a standby state.

When a primary battery is used as the battery, it is required for the user to conduct battery exchange, with the result that the operating cost of the sensor net system becomes high. When a secondary battery is employed as the battery, on the other hand, when the remaining battery level is low, the battery requires to be charged. However, the operating cost of the secondary battery can be suppressed when compared with that of the primary battery. When the secondary battery is used for a sensor node, it is necessary to minimize a power consumed by a circuit, to prolong a battery life, and for the user to be able to easily know the timing of the battery exchange.

The secondary battery is classified into some types: a nickel-metal hydride secondary battery for use in a portable AV device or the like, an alkaline secondary battery for use in a cordless phone or the like, a lithium ion secondary battery for use in a potable phone, a notebook-sized personal computer or the like, and a lead-acid battery for use in an automobile or the like. The nickel-metal hydride secondary battery has been conventionally used mainly for the portable phone or notebook-sized personal computer. As devices are required to have more power consumption and increased capacity, however, the lithium ion secondary battery has recently been these years employed in portable devices. When compared with the nickel-metal hydride secondary battery, the lithium ion secondary battery has many advantages including high rated voltage per one cell, high weight energy density, no temporary reduction of a discharge capacity (memory effect) caused by repetitive shallow discharge, less self discharge, and virtually no heat generation during charging operation. During the charging of the secondary battery, further, there is no voltage peak in the vicinity of a full-charge level and as the battery is charged, the battery voltage continuously increases. For this reason, when the battery voltage exceeds a constant level, this causes deterioration of battery characteristics and reduction of its safety. To avoid this, in the lithium ion secondary battery, a constant-current/constant-voltage charging (which will be referred to as the CCCV charging, hereinafter) is employed. That is, a charge upper limit voltage is set, constant current charging operation is carried out before the battery voltage reaches the upper limit voltage, and after the battery voltage reaches the upper limit voltage, the operational mode is changed to a constant voltage charging mode (refer to a magazine ‘Transistor Techniques’, 2002, July, an article entitled “Practical Knowledge of Lithium Ion Secondary Battery Pack”, CQ Publishing).

As has been mentioned above, typical one of radio information terminals using the secondary battery is known as a portable telephone. A micro controller exclusively for control of charge/discharge of a secondary battery pack for the portable telephone is mounted in the battery pack. A timer is used to activate the micro controller exclusively for control of charge/discharge of the battery at intervals of a constant time. So that the battery voltage is converted into a digital voltage by an A/D converter, and the digital voltage is compared with a set voltage by the charge/discharge control exclusive micro controller for charge/discharge control. Further, the micro controller for exclusive control of charge/discharge as well as a micro controller for radio communication or voice processing provided in its main body side of the portable telephone are connected by a serial bus to inform the main-body side micro controller of data about the remaining battery amount or the like and to display it on a display or the like. At this time, if the main-body side micro controller is in is standby mode, then the main-body side micro controller is shifted by an interrupt signal to an operational mode. Thereafter the remaining battery amount display, the battery exchange notification, or the like is carried out (refer to JP-A-11-234919). For the purpose of standardizing a secondary-battery charge/discharge control system for a portable device, in particular, for a notebook-sized personal computer, there is a standard called smart battery system. In the standard, communication protocol, data type and so on for data transfer between the secondary-battery charge/discharge control system, the battery side and the main-body side are standardized. This standardization is intended to shorten the developing period of the charge/discharge control system including the battery pack and also to reduce a cost based on the employment of mass production of circuit constituent components.

The aforementioned charge/discharge control circuit of the prior art, which uses the A/D converter having a relatively high power consumption for voltage monitoring, compares the voltage value of the secondary battery converted into the digital value with the set value to cause the micro controller to control the battery charge/discharge. Further, a terminal is provided with control circuits for both charge control and discharge control. When the terminal is operated only on a battery, the charge control circuit is unnecessary and therefore an unnecessary power is consumed, leading to a shortened battery life.

In the prior art using the A/D converter for voltage monitoring, when the voltage of the secondary battery is not lower than a discharge stop voltage and not higher than a charge stop voltage, the charge control is unnecessary. Even in such a case, the A/D converter, the discharge control circuit, and the micro controller are operated, which results in a large power consumption. In this way, the charge/discharge control circuit of the prior art is not suitable for such a sensor node as to require a long battery life.

### SUMMARY OF THE INVENTION

It is an object of the present invention to provide a charge/discharge control circuit which can be operated with a low power consumption, can have a small mounting surface area on a sensor node, and can easily inform a user of charge notification; and also to provide such a sensor node.

Typical means used in the present invention are as follows. That is, the charge/discharge control circuit and the sensor node in accordance with an aspect of the present invention have a comparator for monitoring a battery voltage, a control circuit for converting an output of the comparator into an interrupt signal, a micro controller for performing charge/discharge control when detecting the interrupt signal, and a switch turned ON or OFF under control of the micro controller. When the battery voltage is not lower than a first predetermined voltage, the switch can be turned OFF to stop the charging operation; whereas, when the battery voltage is not higher than a second predetermined voltage, the switch can be turned OFF to stop the discharging operation.

In this case, since the comparator for detecting the battery voltage not lower than the first predetermined voltage and the switch for stopping the charging operation in the above charge/discharge control circuit become unnecessary when the battery charger is connected and operated only on the battery. Thus such a charge control circuit can be suitably mounted in a charger side. Further, when the battery voltage is not higher than the second predetermined voltage, it is desirable for the charge/discharge control circuit to inform a base station of the fact of necessary charging operation by radio communication.

In accordance with the present invention, the charge/discharge control circuit can be operated with a low power consumption and thus its battery life can be correspondingly prolonged. By mounting in the charger side the charge control circuit and a charge stop switch unnecessary when the charge/discharge control circuit is operated only on the battery; there can be provided a charge/discharge control circuit which can decrease its mounting surface area, and also be provided a sensor node based thereon. In addition, the circuit can inform the base station of the fact of necessary charging operation by radio communication and therefore the user can easily conduct its maintenance.

### BRIEF DESCRIPTION OF THE DRAWINGS

FIG. 1 shows a block diagram of an arrangement of a charge/discharge control circuit and a sensor node in accordance with a first embodiment of the present invention;

FIG. 2A shows a circuit diagram of an arrangement of a discharge stop switch in the first embodiment;

FIG. 2B shows a circuit diagram of an arrangement of a charge stop switch in the first embodiment;

FIG. 3 shows a circuit diagram of an arrangement of a voltage monitor interruption circuit in the first embodiment;

FIG. 4 shows a block diagram of an arrangement of a charge control circuit in the first embodiment;

FIG. 5 shows waveforms showing circuit operation when constant-current/constant-voltage charging in the first embodiment is carried out;

FIG. 6 shows waveforms showing circuit operation when the first embodiment is in an overdischarge mode;

FIG. 7 is a table for explaining CPU operational states of the first embodiment;

FIG. 8 is a flow chart for explaining a processing flow of the first embodiment;

FIG. 9 shows waveforms of a consumed current when the first embodiment is in a discharge control mode and in an overdischarge standby mode;

FIG. 10 shows a block diagram of an arrangement of a charge/discharge control circuit and a sensor node in accordance with a second embodiment of the present invention;

FIG. 11 shows a circuit diagram of an arrangement of a voltage monitor interruption circuit in the second embodiment;

FIG. 12 shows a block diagram of an arrangement of a charge/discharge control circuit and a sensor node in accordance with a third embodiment of the present invention;

FIG. 13A shows a circuit diagram of an arrangement of a discharge stop switch, a charge stop switch, a regulator REG, and a secondary battery in the third embodiment, but not including any rectifier diode;

FIG. 13B shows a circuit diagram of an arrangement of the discharge stop switch, charge stop switch, regulator REG, and secondary battery in the third embodiment, but including rectifier diodes;

FIG. 14 shows a circuit diagram of an arrangement of a voltage monitor interruption circuit in the third embodiment;

FIG. 15 shows a structure when a micro controller control circuit board, a charge/discharge control board, and a secondary battery in the present invention are arranged in a stacked form;

FIG. 16 shows an arrangement of the present invention in a non-contact charge mode;

FIG. 17A is a diagram showing a relationship between a sensor node and a charger in the present invention; and

FIG. 17B is a diagram showing a relationship between a sensor node and a charger in the present invention.

### DESCRIPTION OF THE EMBODIMENTS

Several preferable embodiments of a charge/discharge control circuit and a sensor node in accordance with the present invention will be explained by referring to the accompanying drawings.

### Embodiment 1

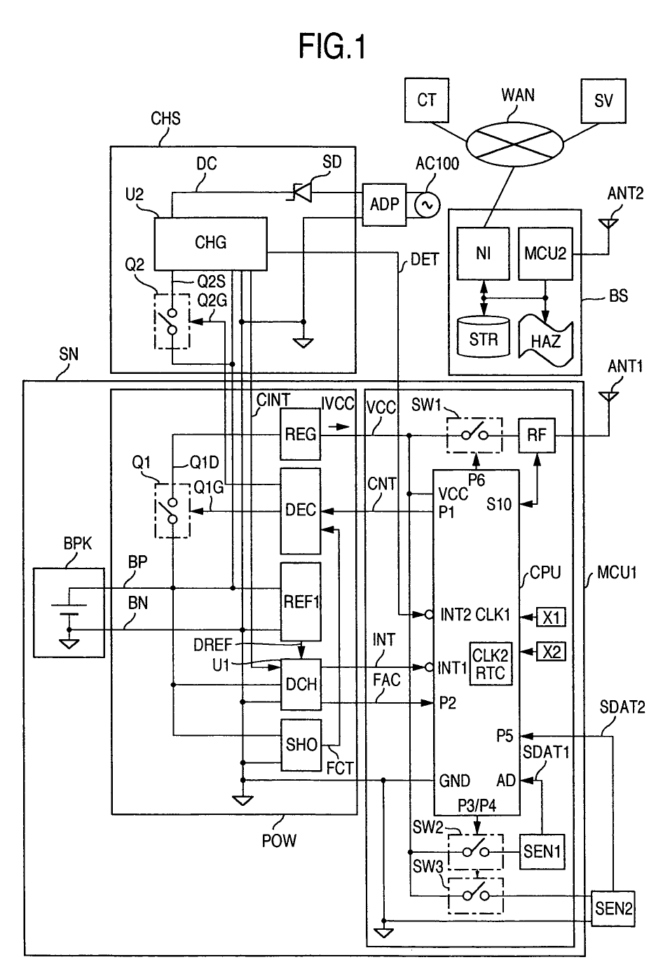

FIG. 1 shows a block diagram of an arrangement of a secondary-battery charge/discharge control circuit and a sensor node in accordance with a first embodiment of the present invention. A sensor net system includes a sensor node SN, a charger CHS, an AC adaptor ADP, a communication network WAN, a radio base station BS, a server SV, and a control center CT connected via the communication network WAN. The sensor node SN informs the radio base station BS of sensed data SDAT1 and SDAT2 by radio communication, the sensed result is displayed on a display device HAZ and stored in a storage STR. And a network interface circuit NI also stores the sensed result in the server SV via the communication network WAN. The control center CT connected to the communication network WAN performs centralized control of the sensor node SN. When a secondary battery BPK mounted in the sensor node SN is required to be charged, the AC adaptor ADP and the charger CHS are connected to the sensor node SN to charge the battery.

The sensor node SN includes the secondary battery BPK, a charge/discharge control circuit POW, a micro controller control circuit MCU1, a sensor SEN2, and an antenna ANT1. In the sensor node SN, a micro controller CPU processes the data SDAT1 and SDAT2 sensed by the first and second sensors SEN1 and SEN2 and informs the radio base station BS of it via a radio communications circuit RF and the antenna ANT1. The data SDAT1 and SDAT2 are displayed on the display device HAZ and also stored in the storage STR.

The micro controller control circuit MCU1 measures an intermittent start time using a timer RTC operated on a subclock X2 to operate a system clock X1 when it comes time to reach a set time. When the micro controller CPU is intermittently operated, the micro controller first puts switches SW2 and SW3 in a conduction state using port terminals P3 and P4 to supply a drive voltage VCC to the sensors SEN1 and SEN2. The micro controller CPU then reads the data SDAT1 and SDAT2 of the sensors SEN1 and SEN2. At this time, the first sensor SEN1, which is mounted in the sensor node SN, outputs the analog data SDAT1 and applies it to an input terminal of an A/D converter. Meanwhile, the second sensor SEN2, which is installed outside of the sensor node SN, outputs the digital data SDAT2 and applies it to a port terminal P5 of the micro controller CPU. The micro controller then puts the switch SW1 in a conduction state using a port terminal P6 to supply the drive voltage VCC to the radio communications circuit RF. Next, the micro controller CPU transmits data to the radio communications circuit RF via a serial interface SI0, while the radio communications circuit RF when receiving the data wirelessly transmits the received data to the radio base station BS. Thereafter, the micro controller CPU again turns OFF the switches SW1, SW2 and SW3 and stops the system clock X1. Thereafter, the sensor node measuring a next-time intermittent start time.

The micro controller control circuit MCU1 performs charge/discharge control of the secondary battery BPK. An interrupt signal INT from the charge/discharge control circuit POW is connected to a first interrupt input terminal INT1 of the micro controller CPU, so that, when the secondary battery BPK is in an overcharge or overdischarge state, the interrupt signal INT is set. The micro controller CPU, after detecting the interrupt signal INT, reads an interrupt cause signal FAC connected to a port terminal P2 of the micro controller CPU, and decides whether the secondary battery BPK is in the overcharge mode or in the overdischarge mode. When the battery is in the overcharge state, the micro controller outputs a switch control signal CNT connected to a port terminal P1 to turn OFF a charge stop switch Q2. Similarly, when the battery is in the overdischarge state, the micro controller turns OFF a discharge stop switch Q1. A charger connection detecting signal DET from the charger CHS is connected to a second interrupt input terminal INT2 of the micro controller CPU, so that, when the AC adaptor ADP and the charger CHS are connected to the sensor node SN, the charger connection detecting signal DET is set. The micro controller CPU, when detecting the charger connection detecting signal DET, the micro controller stops its own operation to cause the secondary battery BPK to be charged with a constant current. The micro controller CPU again starts its operation when the battery completes its constant-current charging operation.

In this way, when the interrupt signal INT and the charger connection detecting signal DET are set, the micro controller CPU is only required to cause the charge/discharge of the secondary battery BPK to be controlled. At all other times, the battery can be put in a standby state requiring a small power consumption, and thus the life of the secondary battery BPK can be prolonged.

The switch SW1 of the radio communications circuit RF is conducted only when radio communication is required; whereas, switches SW2 and SW3 for power supply to the sensors SEN1 and SEN2 are conducted only when sensing operation is required. The sensor SEN1 or SEN2 is, for example, a temperature sensor, a humidity sensor, a pulse sensor, or a sound sensor; and may be incorporated in the micro controller unit MCU1 or be provided outside thereof. Through such intermittent start operation, the power consumption of each circuit can be made small. Simultaneously, the system clock X1 of the micro controller unit MCU1 is operated only when the sensing operation, radio communication operation, or charge/discharge control operation is required in the micro controller unit MCU1. And when such operation is unnecessary, only the subclock X2 supplied to the timer RTC for counting an intermittent start time is operated to thereby reduce a power consumption in the standby mode. Although the timer RTC built in the micro controller CPU has been used as the timer for counting the intermittent start time in the present embodiment, another external timer may be used therefor.

The charge/discharge control circuit POW has the discharge stop switch Q1, a regulator REG, a voltage monitor interruption circuit DCH, a discharge stop reference level generator REF1, a switch control circuit DEC, and an overcurrent detection circuit SHO. A positive terminal BP of the secondary battery BPK is connected via the discharge stop switch Q1 to the regulator REG for generating the drive voltage VCC of the micro controller unit MCU1. When the secondary battery BPK is put in the overdischarge state, the aforementioned means turns OFF the discharge stop switch Q1 and the regulator REG has an output voltage VCC of 0 volts. The discharge stop reference level generator REF1 generates a discharge stop reference voltage level DREF using the battery voltage BP and a ground potential BN of the secondary battery BPK. The generated voltage is compared by the voltage monitor interruption circuit DCH with the positive terminal BP of the secondary battery BPK. When the positive terminal BP of the secondary battery BPK is not higher than the discharge stop reference voltage level DREF, the voltage monitor interruption circuit DCH outputs the interrupt signal INT and the interrupt cause signal FAC to the micro controller unit MCU1. When a lithium ion secondary battery is used, the value of the discharge stop reference voltage level DREF is set generally at about 2.3V. Even when a charge stop voltage detection signal CINT from the charger CHS is set, the voltage monitor interruption circuit DCH generates and outputs the interrupt signal INT and the interrupt cause signal FAC. The interrupt signal INT is set when the secondary battery BPK is in the overdischarge or overcharge state; whereas, the interrupt cause signal FAC indicates the cause of generation of an interrupt.

The micro controller CPU, when receiving the interrupt signal INT from the first interrupt input terminal INT1, operates the system clock X1, transits the micro controller CPU in its operable state, and outputs the switch control signal CNT to the switch control circuit DEC according to the interrupt cause signal FAC. The switch control circuit DEC when receiving the switch control signal CNT sets a control signal Q2G of the charge stop switch Q2 at a high level in the charge stop mode to turn OFF the charge stop switch Q2 and to control the secondary battery BPK not to be further charged. Similarly, the switch control circuit DEC in the discharge stop mode sets a control signal Q1G of the discharge stop switch Q1 at a high level to turn OFF the discharge stop switch Q1 and to control the secondary battery BPK so as not to be further discharged.

Generally speaking, the secondary battery has a likelihood of heat generation or ignition caused by overcharging or a likelihood of accelerating the deterioration of the battery caused by overdischarging. In order to avoid such problems, the charge stop switch Q2 and the discharge stop switch Q1 are controlled to protect the secondary battery.

The micro controller CPU, before turning OFF the discharge stop switch Q1, informs the battery level state to the radio base station BS via the radio communications circuit RF and the antenna ANT1. Thereafter, the micro controller turns OFF the discharge stop switch Q1 to prevent the secondary battery BPK from being deteriorated by being overdischarged. Under this condition, if the battery level state received at the radio base station BS is the discharge stopping state, then the user can connect the charger CHS and AC adaptor ADP to the sensor node SN to charge the battery. The battery level state may be informed by lighting an LED provided to the terminal, by sounding a beep sound, or the like as another method.

When an overcurrent flows through a circuit connected to the secondary battery BPK, an overcurrent detection circuit SHD detects the overcurrent, and outputs an overcurrent detection signal FCT to turn OFF the discharge stop switch Q1 via the switch control circuit DEC. In this case, for the purpose of preventing the heat generation or ignition of the secondary battery BPK or the damage of the circuit, the overcurrent detection circuit will not inform the micro controller unit MCU1 of the overcurrent fact but immediately turn OFF the discharge stop switch Q1 using the overcurrent detection signal FCT. This is because, in order to minimize the damage of the circuit by the overcurrent, it is important to stop the current as quickly as possible. The cause of the overcurrent may be the erroneous operation of the micro controller unit MCU1. In this case, the switch can be advantageously turned OFF more reliably by instructing the switch control circuit DEC to directly turn OFF the switch.

The charger CHS has a charge control circuit CHG, a backflow preventer SD, and the charge stop switch Q2. The charger CHS is used to charge the secondary battery BPK connected to the sensor node SN. Thus when the charger CHS is connected to the AC adaptor ADP and then to the sensor node SN, the charger outputs the charger connection detecting signal DET. When the charge control circuit CHG detects an overcharge state of the secondary battery BPK, the circuit sets the charge stop voltage detection signal CINT to cause the signal to be interrupted into the micro controller CPU. For stopping the overcharging, the micro controller CPU outputs the switch control signal CNT to turn OFF the charge stop switch Q2 and to stop the charging operation. In order to monitor the voltage of the secondary battery BPK during the charging operation, the positive and negative terminals BP and BN of the secondary battery BPK are connected.

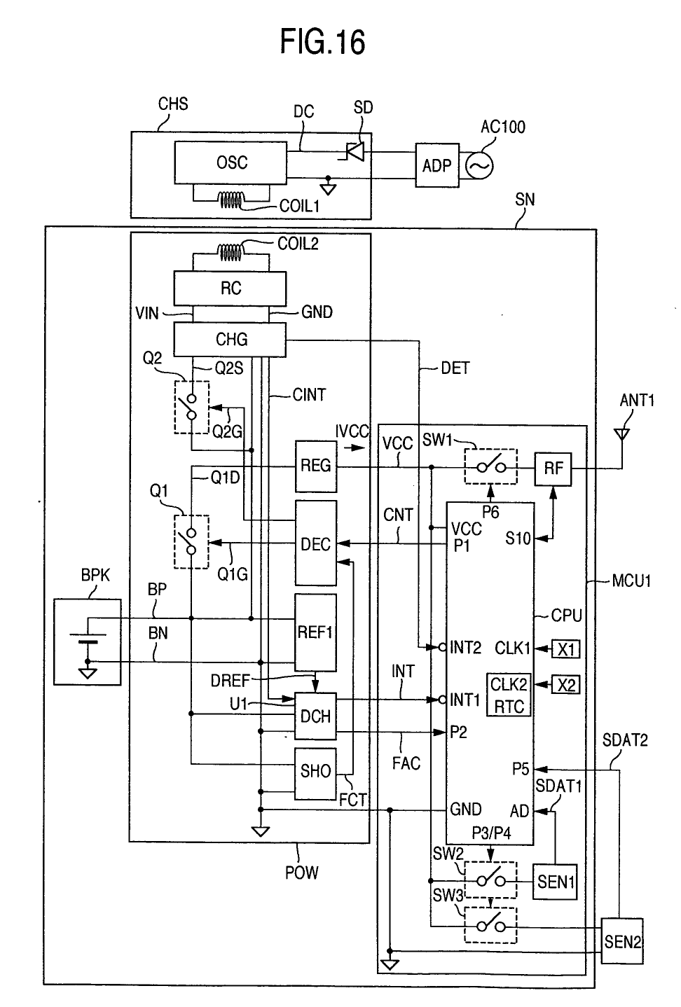

In the embodiment of FIG. 1, the charger CHS and the sensor node SN are connected by cable, that is, wired. In connection with FIG. 16, a non-contact type charging system will be explained. In the non-contact type charging system, a magnetic field generator circuit OSC and a primary coil COIL1 are provided in the charger CHS side; and a secondary coil COIL2 and a rectifier circuit RC are provided in the sensor node SN side. The magnetic field generator circuit OSC of the charger CHS generates an AC voltage having a frequency of several tens of kHz and applies it to the primary coil COIL1 to induce a magnetic field. The magnetic field induced by the primary coil COIL1 is received by the secondary coil COIL2 to obtain an AC voltage. The AC voltage is converted by the rectifier circuit RC to a DC voltage VIN, which in turn is input to the charge control circuit CHG. When the non-contact type charging system is employed in this manner, the need of providing a connector for connecting the sensor node SN and the charger CHS can be eliminated and thus the sensor node SN can be sealed into a plastic case or the like.

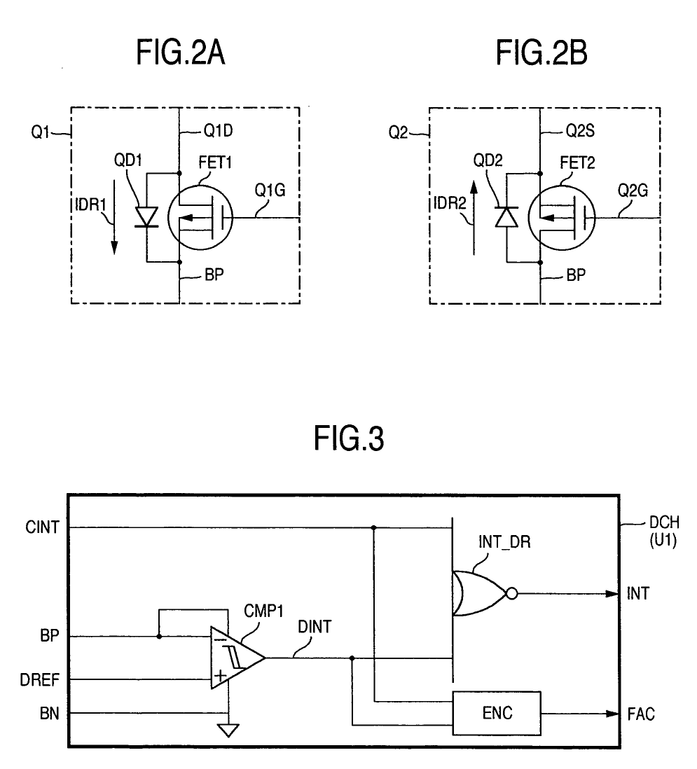

FIGS. 2A and 2B show exemplary arrangements of the discharge stop switch Q1 and the charge stop switch Q2. More specifically, FIG. 2A is an example of the arrangement of the discharge stop switch Q1. The discharge stop switch Q1 comprises a P-channel field effect transistor FET1. When the discharge stop switch control signal Q1G has a high level, the P-channel field effect transistor FET1 is cut off between a source BP and a drain Q1D. When the discharge stop switch control signal Q1G has a low level, on the other hand, the P-channel field effect transistor FET1 is conducted between the source BP and the drain Q1D.

The P-channel field effect transistor FET1 has a parasitic diode QD1. For this reason, even when the discharge stop switch control signal Q1G has a high level, a reverse drain current IDR1 flows therethrough. The embodiment of FIG. 1 is arranged so that a current in the charge mode flows directly into the secondary battery BPK. However, the charger may be connected via the discharge stop switch Q1. In this case, the charging current flows into the secondary battery BPK due to the reverse drain current IDR1 flowing through the parasitic diode QD1. Since a voltage drop occurs across the discharge stop switch Q1, however, it is necessary, in the charge mode, to set an application voltage to the secondary battery to be higher by the voltage drop.

FIG. 2B is an example of the arrangement of the charge stop switch Q2. The charge stop switch Q2 comprises a P-channel field effect transistor FET2. When a charge stop switch control signal Q2G has a high level, the P-channel field effect transistor FET2 is cut off between its source Q2S and drain BP. When the charge stop switch control signal Q2G has a low level, on the other hand, the P-channel field effect transistor FET2 is conducted between the source Q2S and the drain BP.

The P-channel field effect transistor FET2 has a parasitic diode QD2. For this reason, even when the charge stop switch control signal Q2G has a high level, a reverse drain current IDR2 flows therethrough. In the embodiment of FIG. 1, the charging current flows from the drain Q1D of the discharge stop switch directly into the regulator REG. However, the charging current may be connected to flow from the charge stop switch Q2 indirectly into the regulator REG. In the latter case, the discharging current flows into the regulator REG due to the reverse drain current IDR2 flowing through the parasitic diode QD2. When the charge stop switch Q2 is mounted in the charger CHS side as shown in FIG. 1, this has an advantage that the sensor node SN can be made small in size.

FIG. 3 shows an example of the arrangement of the voltage monitor interruption circuit DCH. The voltage monitor interruption circuit DCH has a comparator CMP1, a logical OR gate INT_OR for generating an interrupt signal, and an interrupt cause generator ENC. The comparator CMP1 compares the battery voltage BP of the secondary battery BPK with the discharge stop reference voltage level DREF. When the battery voltage BP of the secondary battery BPK is not higher than the discharge stop reference voltage level DREF, the comparator sets a discharge stop voltage detection signal DINT at a high level. When any of the charge stop voltage detection signal CINT and the discharge stop voltage detection signal DINT is set through the operation of the logical OR gate INT_OR, the interrupt signal INT is set at a low level. The interrupt input terminal INT1 of the CPU of the micro controller unit MCU1 is initialized to detect the low level signal as an interrupt signal. The interrupt cause signal FAC is set by the interrupt cause generator ENC at a low level at the time of interruption of the discharge stop voltage detection signal DINT. The interrupt cause signal FAC is set at a high level at the time of interruption of the charge stop voltage detection signal CINT.

In the present embodiment, the charge stop voltage detection signal CINT and the discharge stop voltage detection signal DINT are applied to the logical OR gate INT_OR, which in turn outputs the single interrupt signal INT. However, the charge stop voltage detection signal CINT and the discharge stop voltage detection signal DINT may be output to the micro controller CPU respectively as independent interrupt signals. Generally, the number of input pins provided to a micro controller is limited and thus it is preferable for the output part to output such interrupt signals as a single interrupt signal.

When voltage monitoring operation is carried out using a comparator as shown in FIG. 3, the voltage monitoring of FIG. 3 can realize power saving and the downsizing of the sensor node SN over the prior art using an A/D converter for voltage monitoring. In the prior art method using the A/D converter, at all times or each time the micro controller detects a voltage, it is required to operate the A/D converter and the micro controller for analyzing the output of the A/D converter. In the case of the arrangement of the voltage monitor interruption circuit DCH of FIG. 3, however, only a small power consumption (about 5 microamperes) necessary for operating the comparator is always required, and it is sufficient to operate the micro controller only when the comparator outputs an interrupt signal. Since the voltage monitor interruption circuit can use the comparator smaller in power consumption than the A/D converter and since a micro controller operating frequency can be reduced, power saving can be realized. Further, the necessary circuit surface area of the voltage monitor interruption circuit of FIG. 3, which is made of the single comparator, the logical circuit, and the interrupt cause generation circuit, can be made smaller than that of the A/D converter including a plurality of comparators.

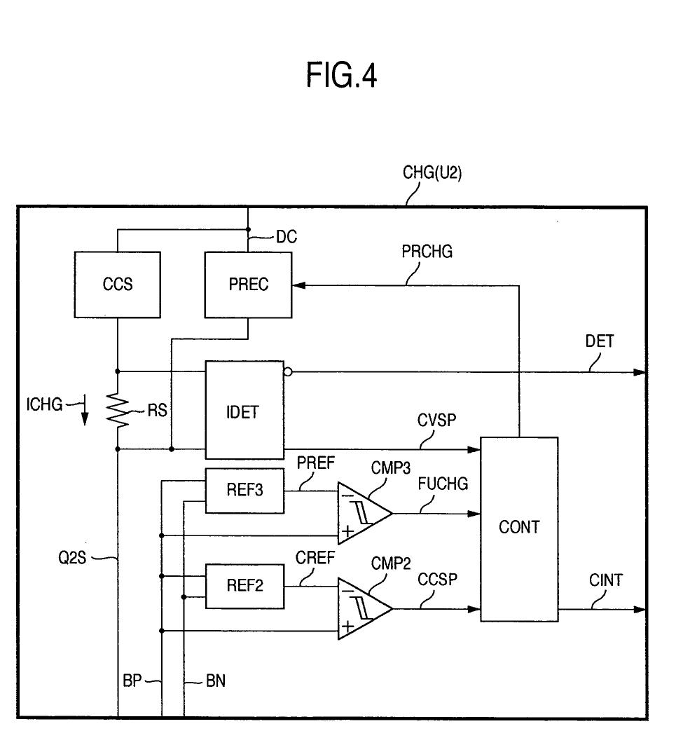

FIG. 4 shows an example of the charge control circuit CHG. The charge control circuit CHG has functions of, when the battery voltage BP of the secondary battery BPK reached a charge stop reference voltage level CREF, informing the voltage monitor interruption circuit DCH of the charge/discharge control circuit POW of the fact with use of the charge stop voltage detection signal CINT; informing the micro controller unit MCU1 of the fact that the charger CHS was connected with use of the charger connection detecting signal DET; and switching between the constant current charge mode and the constant voltage charge mode. The charge control circuit CHG has a constant current source CCS, a precharge circuit PREC, a current detection circuit IDET, a discharge stop reference level generator REF2, a precharge reference level generator REF3, comparators CMP2, CMP3, and a charge control circuit CONT. The discharge stop reference level generator REF2 and the precharge reference level generator REF3 are operated in the same operational manner. When a lithium ion secondary battery is generally employed, it is preferable to set the charge stop reference voltage level CREF at 4.3V, and a precharge reference voltage level PREF at about 2.5 to 3.0V. In this case, the comparator CMP2 compares the battery voltage BP of the secondary battery BPK with the charge stop reference voltage level CREF. When the battery voltage BP of the secondary battery BPK is not lower than the charge stop reference voltage level CREF, the comparator CMP2 has an output (charge stop voltage comparison result) CCSP of a high level. Similarly, the comparator CMP3 compares the battery voltage BP of the secondary battery BPK with the precharge reference voltage level PREF. When the battery voltage BP of the secondary battery BPK is not lower than the precharge reference voltage level PREF, a precharge decision signal FUCHG output to the charge control circuit CONT is changed to a high level. When the AC adaptor ADP is connected, the current detection circuit IDET detects the connected fact by detecting a charge current ICHG, and sets the charger connection detecting signal DET at a low level. When the charge current reaches 0.1 C and the charging operation is completed, the current detection circuit sets a charge stop detection signal CVSP at a high level. The charge control circuit CONT sets a precharge control signal PRCHG until the precharge decision signal FUCHG becomes a high level, to charge the battery via the precharge circuit PREC. When the charge stop voltage comparison result CCSP as the output of the comparator CMP2 is set at a high level, the charge control circuit CONT sets the charge stop voltage detection signal CINT at a low level; whereas, when the charge stop detection signal CVSP is set at a high level, the charge control circuit CONT sets the charge stop voltage detection signal CINT at a high level. When voltage monitoring is carried out using the comparators as shown in FIG. 4, the power consumed in the voltage monitoring circuit part can be made smaller than that of the prior art using the A/D converters. Therefore, the charging time can be made shorter than that of the method of the prior art.

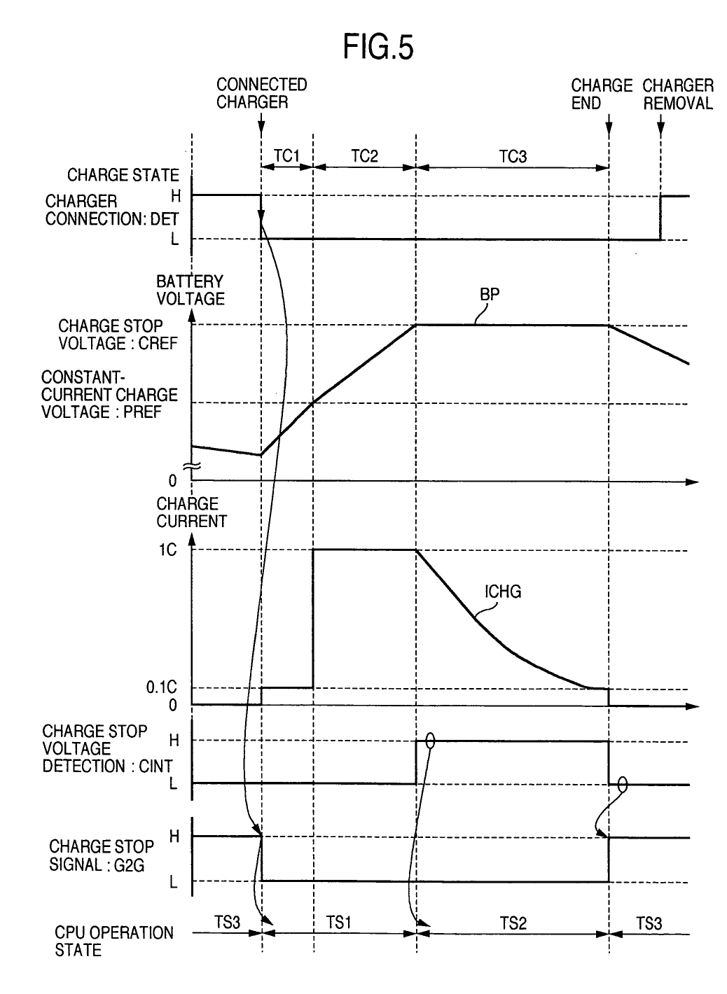

Explanation will then be made, by referring to FIG. 5, as to charge states TC1 to TC3, a charger connection detecting signal DET, a battery voltage BP, a charging current ICHG, a charge stop voltage detection signal CINT, the charge stop signal G2, and CPU operational states TS1 to TS3 when the secondary battery is Constant Current Constant Voltage CCCV charged. When the battery is charged, the user first connects the AC adaptor ADP, whereby the charger connection detecting signal DET is set at a low level, the micro controller CPU sets a charge stop switch control signal G2G at a low level to put the charge stop switch Q2 in the conduction state and to transit the CPU operational state to a charge standby mode TS1. At this time, when it is tried to charge the secondary battery BPK, this means to make a normal charging current 1C to flow into the secondary battery BPK having the extremely-reduced voltage BP, so that battery may be abnormally heated. To avoid this, when the precharge decision signal FUCHG shown in FIG. 4 is at a low level, that is, when the battery voltage BP of the secondary battery BPK is not higher than the precharge reference voltage level PREF, the precharge circuit PREC is used to charge the secondary battery BPK with a current of about 0.1 C until the battery voltage BP increases to the precharge reference voltage level PREF or higher level (charge state TC1). The then precharge reference voltage level PREF is about 2.5V to 3.0V. Thereafter, the battery is charged with a current of about 1 C using the constant current source CCS shown in FIG. 4 (charge state TC2). When the voltage reaches the charge stop reference voltage level CREF, the charge stop voltage detection signal CINT is set at a high level and the CPU operational state is transited to a quasinormal standby mode TS2. At this time, the charge stop reference voltage level CREF is about 4.3V. Thereafter, the battery is charged with a constant voltage until the charging current ICHG reaches about 0.1 C (charge state TC3). When the charging current ICHG arrives at 0.1 C, the charge stop voltage detection signal CINT is cleared to low level and the CPU operational state is transited to the normal standby mode TS3. In a time duration (of the charge states TC1 and TC2) after the charger connection detecting signal DET is set until the constant current charging operation is completed, if the micro controller CPU shown in FIG. 1 is tried to operate, a current IVCC flows through the regulator REG, whereby a charging efficiency for the secondary battery BPK is reduced. Accordingly, when the micro controller CPU receives the charger connection detecting signal DET, the battery is put in the standby mode wherein no other operation is carried out until the charge stop voltage detection signal CINT is set, and is controlled so that the full charging current ICHG shown in FIG. 4 flows into the secondary battery BPK.

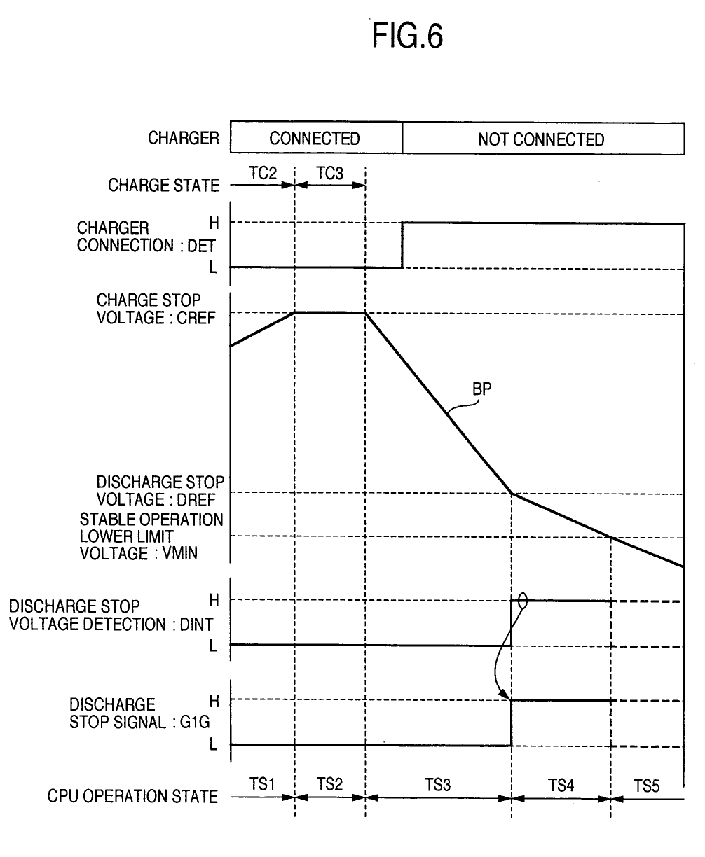

By referring to FIG. 6, explanation will be made as to the battery voltage BP of the secondary battery BPK, the discharge stop voltage detection signal DINT, the discharge stop switch control signal G1G, and CPU operational states TS1 to TS5, when the sensor node SN driven by the secondary battery BPK is discharged. When the battery voltage BP of the secondary battery BPK is not higher than the discharge stop reference voltage level DREF, the discharge stop voltage detection signal DINT is set at a high level so that the CPU operational state is changed to the power down mode TS4. At this time, the discharge stop reference voltage level DREF is at about 2.3V. Thereafter, when the charger CHS is not connected and the secondary battery BPK is not charged, the battery voltage BP of the secondary battery BPK drops to a stable operation lower limit voltage VMIN or less, with the result that the charge/discharge control circuit POW of the sensor node SN is put in the unstable mode TS5. Thereafter, if the battery is again charged, then the CPU operational state is returned to the charge standby mode TS1 for normal operation.

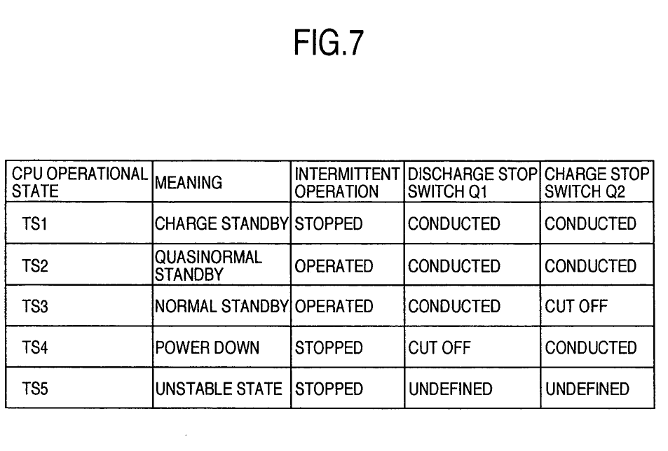

FIG. 7 is a table for explaining the aforementioned CPU operational states. In the charge standby mode TS1, the secondary battery BPK is precharged and charged with a constant current. Due to the constant-current charging, the intermittent operation is stopped so that the discharge stop switch Q1 and the charge stop switch Q2 are both conducted. In the quasinormal standby mode TS2, the secondary battery BPK is charged with a constant voltage and the intermittent operation is possible. In the normal standby mode TS3, the charging of the secondary battery BPK is completed and the charge stop switch Q2 is turned OFF, so that it is possible to drive the sensor node SN only by the secondary battery BPK and the intermittent operation can be carried out. In the power down mode TS4, the sensor node SN cannot further perform its intermittent operation and the discharge stop switch Q1 is turned OFF, so that the drive voltage VCC of the micro controller unit MCU1 is at 0 volts. In the unstable mode TS5, the battery voltage BP of the secondary battery BPK drops to the aforementioned stable operation lower limit voltage VMIN or less, so that the charge/discharge control circuit POW cannot be operated normally and the state of the discharge stop switch Q1 and the state of the charge stop switch Q2 are also unstable. Thereafter, if the battery is again charged, then the CPU operational state is returned to the charge standby mode TS1 for normal operation.

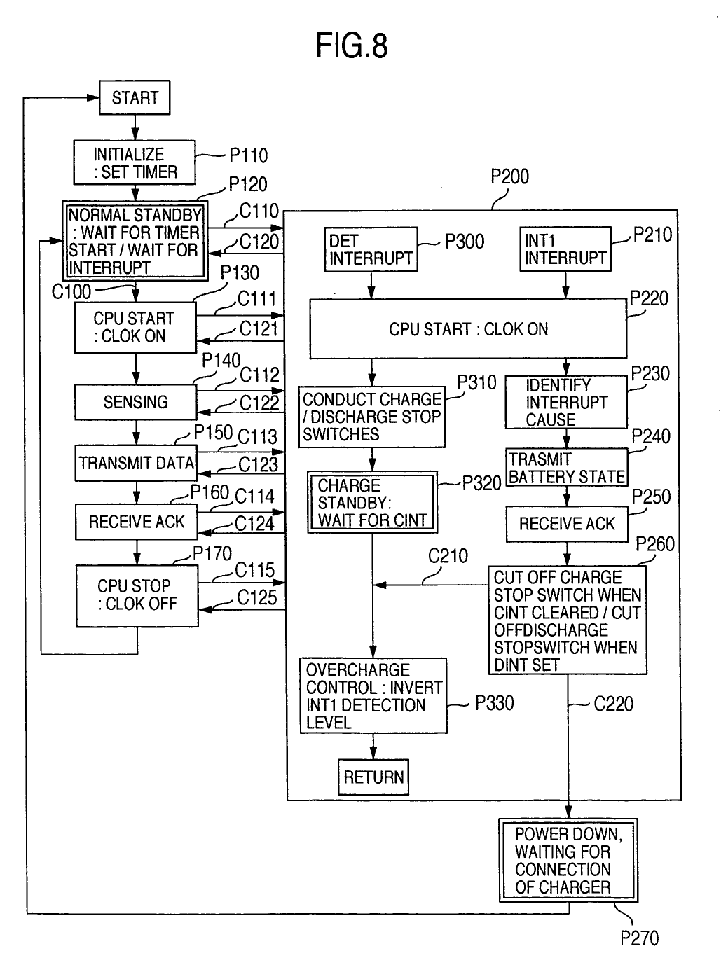

FIG. 8 is a flow chart for explaining the processing operation of the sensor node SN.

P110: Initialization including setting of the intermittent start time of the sensor node in the timer is carried out.

P120: The sensor node is in the normal standby mode. When the sensor node waits for a timer start and an interrupt. If a timer start occurs, then the sensor node outputs a signal C100. If the interrupt signal INT or the charger connection detecting signal DET shown in FIG. 1 occurs, then the sensor node outputs a signal C110.

P130: Operates the system clock X1 to put the micro controller CPU in the operable state.

P140: The power supply switches SW2 and SW3 for the first and second sensors SEN1 and SEN2 shown in FIG. 1 are conducted for sensing, and the micro controller CPU reads the sensed data SDAT1 and SDAT2.

P150: The power supply switch SW1 for the radio communications circuit RF shown in FIG. 1 is turned ON, so that the data sensed in the sensing P140 is wirelessly transmitted to the radio base station BS shown in FIG. 1.

P160: The sensor node SN receives an ACK signal indicative of the fact that the radio base station BS of FIG. 1 has received correctly. Although an ACK receiving flow is provided in the sensor node SN side in the present embodiment, the sensor node SN can perform its transmitting operation and omit the ACK receiving flow. In order for the user to correctly recognize the data transmitted from the sensor node SN side, however, it is preferable to provide the ACK receiving flow.

P170: The system clock X1 shown in FIG. 1 is stopped to put the micro controller CPU in the standby mode.

In the normal standby mode P120, the CPU start mode P130, the sensing mode P140, the data transmission mode P150, or the CPU stop mode P170; if the interrupt signal INT or the charger connection detecting interrupt signal DET occurs, then the processing is shifted to a charge/discharge control processing flow P200, with the signals C110, C111, C112, C113, C114 and C115 respectively. When the processing of the charge/discharge control processing flow P200 is completed, the sensor node is returned to the initial states of the interrupt occurrence, with signals C120, C121, C122, C123, C124 and C125, respectively.

P200: A charge/discharge control processing flow when the sensor node detects the interrupt signal INT or the charger connection detecting interrupt signal DET in FIG. 1.

P210: When detecting the interrupt signal INT in FIG. 1, the sensor node starts an interrupt handler.

P220: The sensor node starts the system clock X1 in FIG. 1 to put the CPU in the operable state.

P230: The sensor node reads the interrupt cause signal FAC in FIG. 1 and identifies the cause of the interrupt. When the detection level of the interrupt input terminal INT1 is set at a low level output, the interrupt is carried out by the charge/discharge control interrupt signal INT of the low level output, and the interrupt cause signal FAC is at a low level output; the sensor node decides that the interrupt cause is due to the detection (overdischarge) of the discharge stop voltage and decides to stop the discharging operation. When the interrupt input terminal INT1 is set at a high level output and the interrupt is carried out by the charge/discharge control interrupt signal INT of the high level output; the sensor node decides that the interrupt cause is due to detection of the charge stop voltage regardless of the level of the interrupt cause signal FAC, and decides to terminate the charging operation.

P240: When detecting the charge completion in an interrupt cause decision state P230, the sensor node informs the radio base station BS of FIG. 1 of the charge completion; whereas, when detecting the overdischarge, the sensor node informs the radio base station BS of the overdischarge, as battery level state information by rectifier circuit RC.

P250: The sensor node receives an ACK signal indicative of the fact that the radio base station BS has correctly received the data transmitted in the battery level state transmission state. In the present embodiment, an ACK receiving flow is provided in the sensor node SN side. However, the sensor node SN may perform only its transmitting operation and may omit the ACK receiving flow. In order for the user to correctly recognize the data transmitted from the sensor node SN, however, it is preferable to provide the ACK receiving flow.

P260: When the sensor node determines that the charge stop voltage detection signal CINT was cleared due to the interrupt cause decided in the interrupt cause decision state P230, the node indicates the charge end, turns OFF the charge stop switch, and goes to an overcharge control state P330 with a signal C210. When determining that the discharge stop voltage detection signal DINT was set, the secondary battery indicates the overdischarge, turns OFF the discharge stop switch, and goes to a power down state P270.

P270: When the discharge stop switch Q1 is turned OFF in the state P260, the drive voltage VCC of the micro controller unit MCU1 is cut off and the micro controller CPU is put in the power down mode. Thereafter, when the charger CHS is connected, it is started by a power-on reset.

P300: When the sensor node detects the charger connection detecting signal DET in FIG. 1, the node starts the interrupt handler.

P310: In order to supply a charging current to the secondary battery BPK in FIG. 1, the charge stop switch Q2 and the discharge stop switch Q1 are turned ON.

P320: As has been explained in FIG. 5, during the precharge state TC1 and the constant-current charge state TC2, if the micro controller CPU is operated, then this causes the current IVCC to flow through the regulator REG and thus it decrease efficiency to charge the secondary battery BPK with a constant current. To avoid this, the charge standby state of the micro controller CPU is kept until the charge stop voltage detection signal CINT is set. When the detection level of the interrupt input terminal INT1 is set at a low level output, when interrupt is carried out by the interrupt signal INT of the low level output, and when the interrupt cause signal FAC is at a high level output; the sensor node can determine that the charge stop voltage detection signal CINT was set.

P330: When the charge stop voltage detection signal CINT is set in the state P320, the sensor node is shifted to this state P330, so that, when the charge stop voltage detection signal CINT is cleared, that is, when the charging operation is completed, the detection level of the interrupt input terminal INT1 is inverted from the low level to the high level so that the interrupt signal INT again occurs. When the state is transited from the above state P260 to this state P330, the detection level of the interrupt signal INT is again inverted from the high level to the low level.

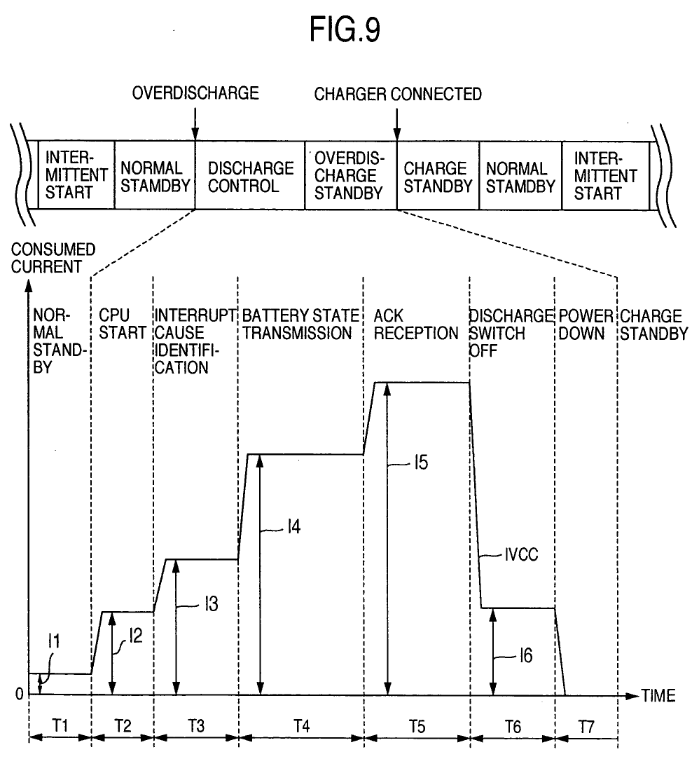

By referring to FIG. 9, explanation will be made as to the consumed current IVCC of the micro controller unit MCU1 when the battery voltage BP of the secondary battery BPK in FIG. 1 becomes not higher than the discharge stop reference voltage level DREF and the sensor node performs its discharge control operation, during the intermittent start operation of the sensor node SN. In a normal standby state T1, a consumed current I1 of the sensor node corresponds to the standby current of the micro controller CPU in FIG. 1 which usually has a value of about 40 microamperes. In the normal standby state T1, the battery voltage BP of the secondary battery BPK is the discharge stop reference voltage level DREF or less. When the overdischarge control is desired, the overdischarge control is carried out in the processing flow explained in FIG. 8. First, a current I2 is consumed to put the micro controller CPU of FIG. 1 in the overdischarge control state. Then when the sensor node reads the interrupt cause signal FAC in FIG. 1 to identify the cause (state T3), a current I3 is consumed. When the sensor node informs the radio base station BS in FIG. 1 of the overdischarge notification, a current I4 is consumed. When the sensor node receives an ACK signal indicative of the fact that the radio base station BS correctly received the data (state T5), a current I5 is consumed. Next, when the discharge stop switch Q1 in FIG. 1 is turned OFF (state T6), a current I6 is consumed and the sensor node is transited to a power down state T7. The currents I2 to I6 are about 2 milliamperes, 3 milliamperes, 7 milliamperes, 15 milliamperes, and 2.5 milliamperes, respectively. In the power down state T7, the drive voltage VCC of the micro controller unit MCU1 is cut off and thus no current is consumed.

Since the sensor node SN is intermittently operated at intervals of a time from several minutes to several hours and transmits the sensed data by radio communication circuit RF, the node is placed in the standby state in most times. Accordingly, the battery life is largely affected by the consumed power in the standby state. In the prior art method, each time the user confirms the battery voltage always or periodically, it becomes necessary to operate the micro controller to analyze the output of the A/D converter. Since it is always or periodically required to put the sensor node in the state T2 in FIG. 9, the current I2 is required regardless of the remaining capacity of the battery. In accordance with the present invention, on the other hand, when it is desired to actually stop the charge/discharge operation (when the sensor node receives the interrupt signal from the comparator), the node is put in the state T2. Therefore, when it is unnecessary to stop the charge/discharge operation, only the consumption of the current I1 is only required, whereby power consumption can be saved and thus the battery life can be prolonged advantageously.

Explanation will then be made as to comparison between the power consumption of the comparator in the present embodiment and the power consumption of the A/D converter used in the prior art method. In the present invention, the comparator is used for comparing the battery voltage BP of the secondary battery BPK with the discharge stop reference voltage level DREF, and generally has a consumed current of about 5 microamperes. When the A/D converter explained in the prior art is used and when the converter has a resolution of, e.g., 8 bits, it is required to mount at least 8 comparators in the A/D converter. This means the prior art consumes a current 8 times as much as the current of the comparator of the invention. Further, when the A/D converter is used, for the purpose of comparing the voltage value digitally converted by the A/D converter with the set voltage, it is necessary to put the micro controller always in the operational mode. As a result, the prior art requires the current 10 times as much as the standby state of the present embodiment. In other words, even in the standby state, the aforementioned current I2 is always consumed. In accordance with the present invention, therefore, in the normal standby mode, the power consumption can be made reduced to ⅛ in the voltage value detection part and to 1/10 in the comparison part. When compared with the A/D converter including the plurality of comparators, the voltage monitor interruption circuit DCH of the present invention can be largely reduced in size.

In the present embodiment, the ACK receiving flow is provided in the sensor node side. However, the sensor node may perform only its transmitting operation and may omit the ACK receiving flow. This is effective, in particular, when it is desired to suppress the consumed current I5 in the ACK receiving flow.

### Embodiment 2

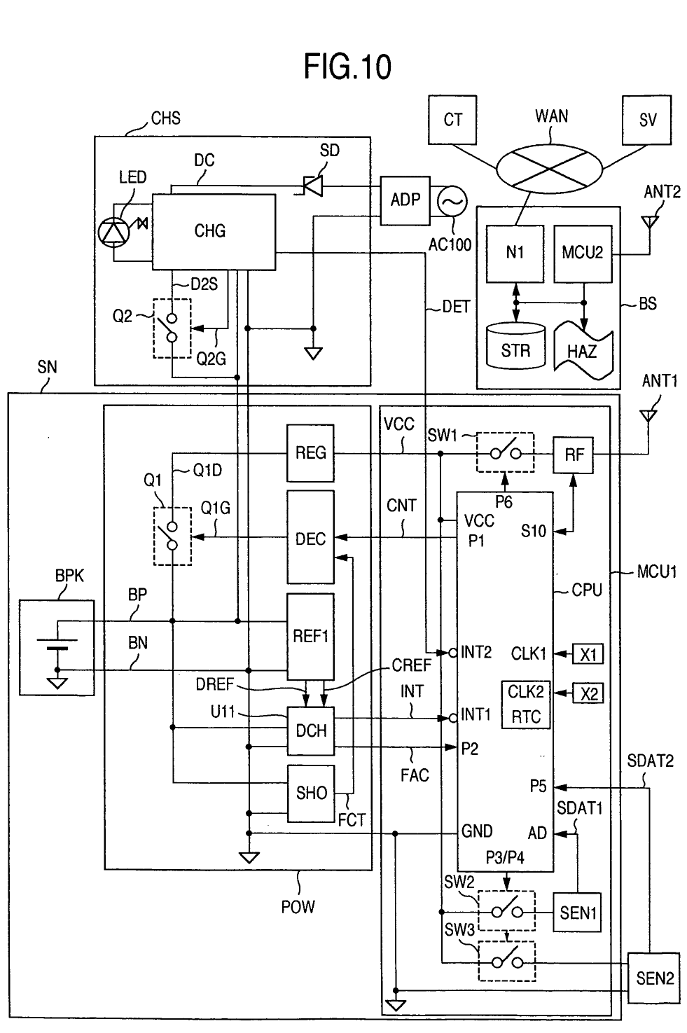

FIG. 10 shows a configuration when the number of signal lines for connection between the charger CHS and the sensor node SN is minimized. The configuration having a minimized number of signal lines for connection between the charger CHS and the sensor node SN can reduce the size of a connector to be mounted to the sensor node SN and thus the size of the sensor node SN can also be reduced. When compared with the first embodiment of FIG. 1, the charge stop voltage detection signal CINT and the charge stop switch control signal Q2G of the charge stop switch Q2 are omitted in the present configuration.

In the first embodiment of FIG. 1, the charge control after the charge stop voltage detection signal CINT is set is carried out under control of the micro controller CPU, and thus there are present signal lines for the charge stop voltage detection signal CINT and the charge stop switch control signal Q2G. In the second embodiment, on the other hand, all the operations until the charge completion are carried out by the charger CHS side. Accordingly, in order not to operate the micro controller CPU until the constant-current charge explained in FIG. 5 is completed, it is necessary for the discharge stop reference level generator REF1 to also generate the charge stop reference voltage level CREF and to mount the comparator for comparing the charge stop reference voltage level CREF and the voltage of the secondary battery BPK in the voltage monitor interruption circuit DCH of the charge/discharge control circuit POW. Since the micro controller CPU cannot decide the charge completion, further, it is also necessary to provide an indicator LED indicative of the charge completion to the charger CHS.

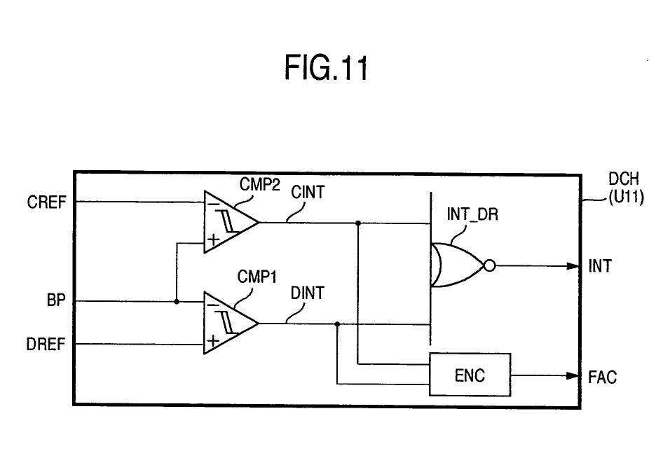

FIG. 11 shows an arrangement of the voltage monitor interruption circuit DCH when the number of signal lines for connection between the charger CHS and the sensor node SN is minimized. The voltage monitor interruption circuit DCH has comparators CMP1 and CMP2, a logical OR gate INT_OR for generating an interrupt signal INT, and an interrupt cause generator ENC. The comparator CMP1 compares the battery voltage BP of the secondary battery BPK with the discharge stop reference voltage level DREF. When the battery voltage BP of the secondary battery BPK is not higher than the discharge stop reference voltage level DREF, the comparator CMP1 sets the discharge stop voltage detection signal DINT at a high level. Similarly, the comparator CMP2 compares the battery voltage BP of the secondary battery BPK with the charge stop reference voltage level CREF. When the battery voltage BP of the secondary battery BPK is not lower than the charge stop reference voltage level CREF, the comparator CMP2 sets the charge stop voltage detection signal CINT at a high level. When any of the charge stop voltage detection signal CINT and the discharge stop voltage detection signal DINT is set at a high level, the interrupt signal INT is set at a low level. When interrupt occurs by the discharge stop voltage detection signal DINT, the interrupt cause signal FAC is set at a low level by the interruption cause generator ENC. Whereas, when interrupt occurs by the charge stop voltage detection signal CINT, the interrupt cause signal FAC is set at a high level.

### Embodiment 3

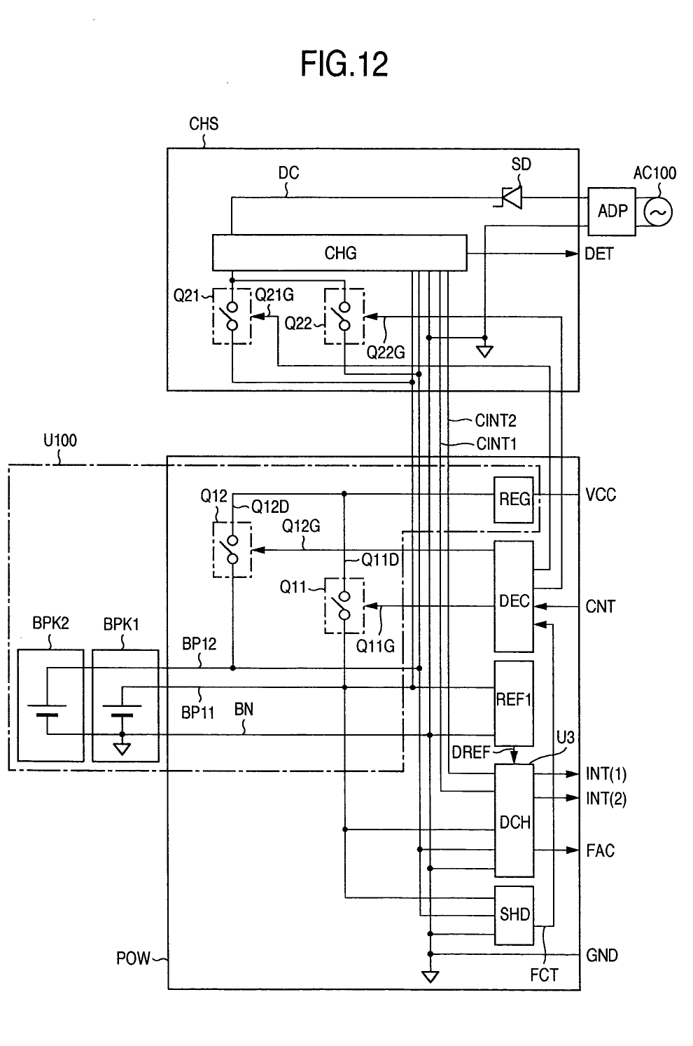

FIG. 12 is a circuit diagram for explaining a configuration when two secondary batteries BPK1 and BPK2 are connected in parallel. The radio communications circuit RF and the sensors SEN1 and SEN2 in the sensor node SN may, in some cases, require relatively large currents. In this case, the secondary batteries are mounted in parallel to increase the current and capacity.

Negative terminals BN of the first and second secondary batteries BPK1 and BPK2 are commonly connected; whereas, positive terminals BP11 and BP12 of the first and second batteries BPK1 and BPK2 are connected to the charge/discharge control circuit POW respectively. The micro controller control circuit MCU1, the second sensor SEN2, and the antenna ANT1 in FIG. 12 have the same structures as those in FIG. 1; and explanation thereof is omitted in FIG. 12. The charge/discharge control circuit POW has a first discharge stop switch Q11, a second discharge stop switch Q12, the regulator REG, the voltage monitor interruption circuit DCH, the discharge stop reference level generator REF1, the switch control circuit DEC, and the overcurrent detection circuit SHO. In this case, the discharge stop reference level generator REF1 generates the discharge stop reference voltage level DREF using a voltage BP11 of the secondary battery BPK1 and the ground potential BN. The voltage monitor interruption circuit DCH compares the received discharge stop voltage DREF with the voltage BP11 of the first secondary battery BPK1. When the voltage BP11 of the first secondary battery BPK1 is not higher than the discharge stop reference voltage level DREF, the voltage monitor interruption circuit DCH generates and outputs and interrupt signal INT(1) and the interrupt cause signal FAC. Similarly, the voltage monitor interruption circuit DCH compares the discharge stop reference voltage level DREF with the voltage BP12 of the second secondary battery BPK2. When the voltage BP12 of the second secondary battery BPK2 is not higher than the discharge stop reference voltage level DREF, the voltage monitor interruption circuit DCH generates and outputs an interrupt signal INT(2) and the interrupt cause signal FAC.

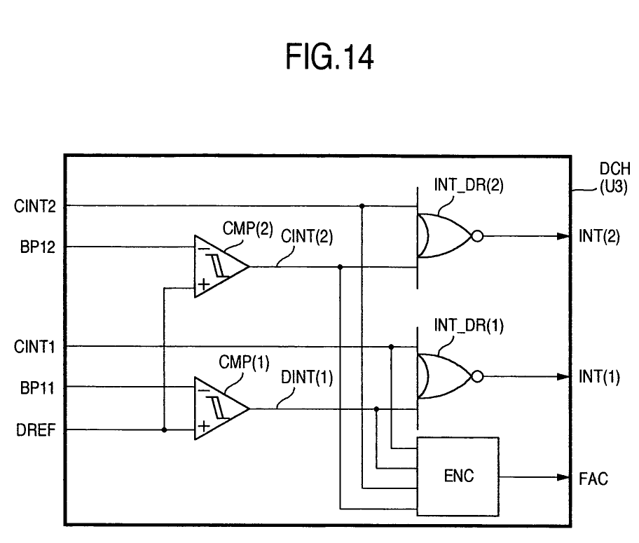

The arrangement of the voltage monitor interruption circuit DCH in accordance with a third embodiment is as shown in FIG. 14. In the arrangement, two comparators CMP(1) and CMP(2) for monitoring the voltages of the two secondary batteries BPK1 and BPK2 are provided in parallel; and charge stop voltage detection signals CINT1 and CINT2 for the two secondary batteries BPK1 and BPK2 are input to the voltage monitor interruption circuit. The charge stop voltage detection signal CINT1 associated with the first secondary battery BPK1 and a discharge stop voltage detection signal DINT(1) are calculated by an OR gate INT_OR(1) to generate and output the first interrupt signal INT(1). Similarly, the charge stop voltage detection signal CINT2 associated with the second secondary battery BPK2 and a discharge stop voltage detection signal DINT(2) are calculated by an OR gate INT_OR(2) to generate and output the second interrupt signal INT(2). The interrupt cause generator ENC monitors the two charge stop voltage detection signals CINT1 and CINT2 and the two discharge stop voltage detection signals DINT(1) and DINT(2), decides whether the cause of an interrupt is by the detection signal of one of the secondary batteries or by the detection signal of the other, generates and outputs the interrupt cause signal FAC of two bits indicative of the cause battery. In the present embodiment, in place of the interrupt input terminal INT1, the micro controller CPU has two terminals, that is, interrupt input terminals INT1(1) and INT1(2). The processing flow of the micro controller CPU in the present embodiment is substantially the same as that explained in FIG. 8. That is, the charge/discharge control is executed by the two interrupt signals INT(1) and INT(2), and the switch control signal CNT is output to the charge/discharge control circuit POW. The switch control circuit DEC turns OFF the first discharge stop switch Q11 when it is desired to stop the discharge of the first secondary battery BPK1 according to the switch control signal CNT. Whereas, the switch control circuit DEC turns OFF the discharge stop switch Q12 when it is desired to stop the discharge of the second secondary battery BPK2. When the micro controller CPU informs the radio base station BS of the battery level state via a radio communications circuit RF and the antenna ANT1, it also may transmit information indicative of the battery level state of one of the secondary batteries together with the notification.

When an overcurrent occurs in a circuit connected to the secondary batteries BPK1 and BPK2, the overcurrent detection circuit SHO detects the overcurrent, and outputs the overcurrent detection signal FCT to turn OFF the discharge stop switches Q11 and Q12 via the switch control circuit DEC.

The charger CHS when the two secondary batteries BPK1 and BPK2 are connected in parallel has a charge stop switch Q21 for the first secondary battery BPK1, a charge stop switch Q22 for the second secondary battery BPK2, a charge controller CHG, and a backflow preventer SD. When the voltage BP11 of the first secondary battery BPK1 is not lower than the charge stop voltage, the charger CHS turns OFF the first charge stop switch Q21 to set the first charge stop voltage detection signal CINT1. Similarly, when the voltage BP12 of the second secondary battery BPK2 is not lower than the charge stop voltage, the charger CHS turns OFF the second charge stop switch Q21 to set the second charge stop voltage detection signal CINT2.

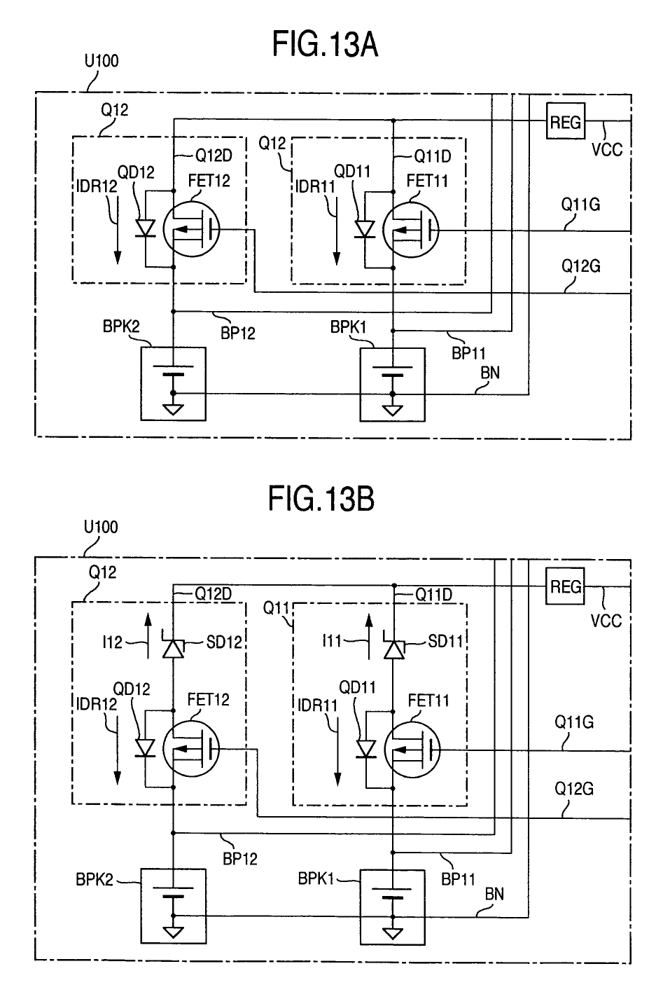

FIGS. 13A and 13B show examples of a discharge circuit unit U100 which includes the secondary batteries BPK1 and BPK2, the discharge stop switches Q11 and Q12, and the regulator REG explained in the FIG. 12. In FIG. 13A, the first and second discharge stop switches Q11 and Q12 comprise P-channel field effect transistors FET11 and FET12 respectively. When a first discharge stop switch control signal Q11G is at a high level, the P-channel field effect transistor FET11 is cut off between its source BP11 and drain Q11D. When the first discharge stop switch control signal Q11G is at a low level, the P-channel field effect transistor FET11 is conducted between the source BP11 and the drain Q11D. Similarly, when a second discharge stop switch control signal Q12G is at a high level, the P-channel field effect transistor FET12 is cut off between its source BP12 and drain Q12D. When the discharge stop switch control signal Q12G is at a low level, the P-channel field effect transistor FET12 is conducted between the source BP12 and the drain Q12D. Since the P-channel field effect transistors FET11 and FET12 have parasitic diodes QD11 and QD12, even when the discharge stop switch control signal Q11G or Q12G is at a high level, reverse drain currents IDR11 and IDR12 flow through the P-channel field effect transistors FET11 and FET12 respectively.

In the arrangement of FIG. 13A, for example, when the first secondary battery BPK1 in a fully charged state and the consumed second secondary battery BPK2 are connected, an action to achieve balance between the voltages of the batteries takes place. For this reason, a current flows from the first secondary battery BPK1 to the second secondary battery BPK2, and thus a less current flows into the regulator REG and its efficiency drops. Even when the discharge stop switch Q11 of the consumed second secondary battery BPK2 is turned OFF, a reverse drain current IDR12 flows through the parasitic diode QD2 of the P-channel field effect transistor FET12. Accordingly, in the arrangement of FIG. 13A, it is preferable to connect batteries having the same voltage and capacity.

Meanwhile, in the case where the second secondary battery BPK12 not charged is connected to the sensor node SN operating only on the first secondary battery BPK11, if discharge current rectifiers SD11 and SD12 for rectifying in directions of discharge currents I11 and I12 are inserted as shown by the arrangement of FIG. 13B, then the above problem can be solved.

Although the above explanation has been made in connection with the two secondary batteries, three or more secondary batteries can be employed with a similar arrangement.

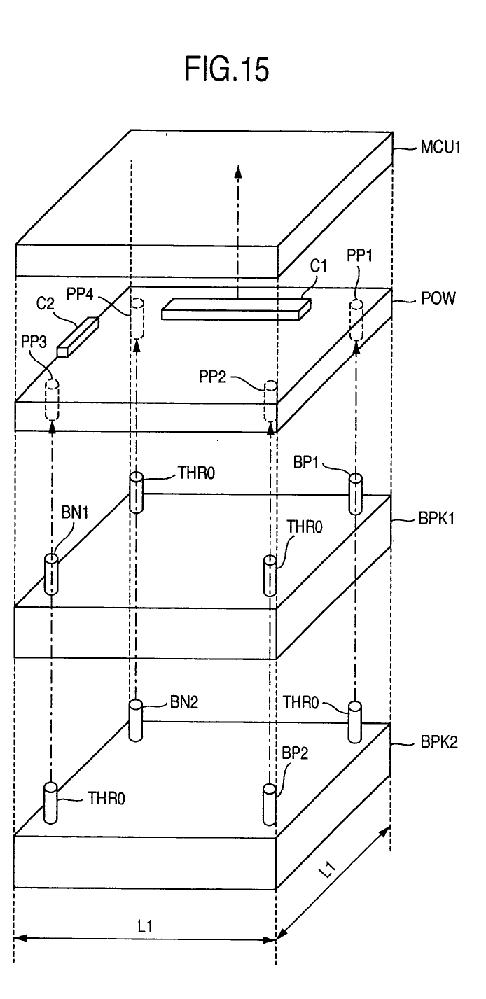

FIG. 15 is a diagram when the two secondary batteries BPK1 and BPK2 are connected in parallel and further stacked together with the charge/discharge control circuit POW board and the micro controller unit MCU1 board. Each of the secondary batteries BPK1 and BPK2 is set to have a square shape of L1×L1; the positive terminals BP1, BP2 and the negative terminals BN1, BN2 are provided at positions which are located on one diagonal line; and through-pins THRO are provided at positions which are located on the other diagonal line. When the first and second secondary batteries BPK1 and BPK2 are connected in a stacked form with the batteries rotated respectively by 90 degrees, the positive terminal BP1 of the first secondary battery BPK1 is connected to a first terminal PP1 of the charge/discharge control circuit POW, the positive terminal BP2 of the first secondary battery is connected to a second terminal PP2 through the first secondary battery through-pin, the negative terminal BN1 of the first secondary battery is connected to a third terminal PP3, and the negative terminal BN2 of the second secondary battery is connected to a fourth terminal PP4 through the first secondary battery through-pin. The charge/discharge control circuit POW board and the micro controller unit MCU1 board are connected by connectors C1, and the charger CHS shown in FIG. 1 is connected to a connector C2.

When the secondary batteries are formed in such a shape, the overall shape of the sensor node SN can be made to have a nearly cubic shape. Therefore, the sensor node can be made resistant to bending or torsion and made small in size compared with when the boards and the secondary batteries are connected in a planar form. Further, when the positions of the positive and negative terminals of the secondary batteries and the positions of the through-pins are devised in the aforementioned manner, all the secondary batteries can have the same shape, which is suitable for its mass production.

The above explanation has been made in connection with the case where each of the secondary batteries and boards is shaped to a square and the number of such secondary batteries is 2. However, the present invention is not limited to the specific example. For example, such a shape that elements can be stacked together, each element being slightly rotated from the adjacent element, for example, regular polygon other than square or circle can be employed. Even when 3 or more secondary batteries are used, the positive and negative terminals of the secondary batteries may be provided diagonally, and through-pins for connection between the two terminals of the other secondary battery may be provided to a remaining outer edge, so that the positive and negative terminals and the through-pins are arranged at equal intervals therebetween.

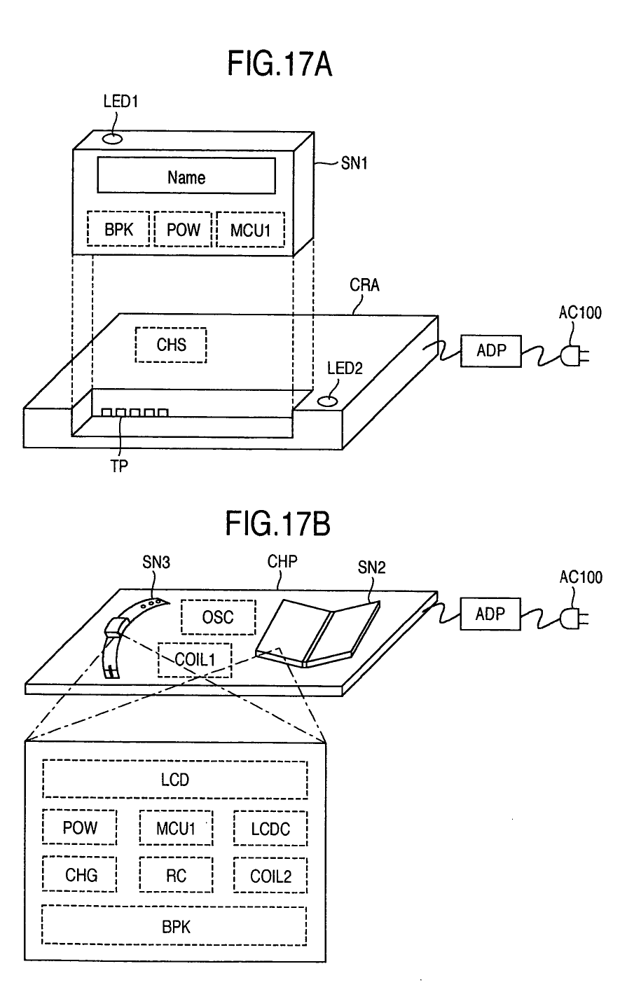

FIGS. 17A and 17B show a configuration of a charger cradle CRA and sensor nodes SN1, SN2 and SN3. In FIG. 17A, the sensor node SN1 has a name plate type structure. That is, the sensor node has the secondary battery BPK, the charge/discharge control circuit POW, and the micro controller unit MCU1 incorporated therein, explained in FIG. 1, which are all packaged in a plastic casing for example. The sensor node also has an indicator LED1 and a charging terminal TP. When it is desired to charge the battery, the sensor node SN1 informs the user of the charge necessity by means of the indicator LED1 or the like. When the user charges the battery and does not use the sensor node SN1, he places the sensor node SN1 on the charger cradle CRA having built therein the charger CHS explained in FIG. 1. When the battery is in the fully charged state, the user can know the fact with use of an indicator LED2 or the like. Since the remaining level of the battery of the sensor node is managed in the radio base station BS shown in FIG. 1, the user can know the battery level state without providing an indicator to the sensor node itself. In particular, when the size of the sensor node SN itself or the power consumption is limited, the indicator LED1 can be removed.

In the configuration of FIG. 17B, the sensor nodes SN2 and SN3 and a charger cradle CHP have no charging terminal. Sensor nodes SN2 and SN3 are charged based on the electromagnetic induction explained in FIG. 16. The charger cradle CHP incorporates a magnetic field generator circuit OSC and a primary coil COIL1 to generate a magnetic field. Each of the sensor nodes SN2 and SN3 has a secondary coil COIL2, a rectifier circuit RC, a charge controller CHG, the secondary battery BPK, the charge/discharge control circuit POW, and the micro controller unit MCU1, explained in FIG. 1. Each sensor node also has a liquid crystal display LCD and a liquid crystal display controller LCDC. The sensor node SN2 is of a book type where a menu of food and drink or the like is written; whereas, the sensor node SN3 is of a bracelet type for measuring user's pulse rate or the like. These sensor nodes are required to be resistive to water. Accordingly, such a sensor node is not provided with any charging terminals, are completely sealed, and are charged based on electromagnetic induction or the like.

In accordance with the present invention, when a small radio terminal driven by a secondary battery is operated intermittently, its discharge control circuit can be realized with a low power consumption. Further, when a charge control circuit, which becomes unnecessary when the terminal is driven by the secondary battery, is provided in the charger side, the terminal can be applied to such applications where miniaturization is indispensable.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A secondary battery control device connected to a secondary battery, comprising:
a discharge stop switch for cutting off a discharge current of said secondary battery;
a first predetermined voltage generation circuit for generating a first predetermined voltage as a discharge stop voltage of said secondary battery;
a voltage monitoring circuit for outputting a comparison result between said first predetermined voltage and the voltage of said secondary battery; and
a central processing unit for controlling said discharge stop switch on the basis of an output of said voltage monitoring circuit,
wherein said voltage monitoring circuit has an interrupt generation circuit which outputs an interrupt signal indicative of a request for controlling said discharge stop switch to said central processing unit as said comparison result when the voltage of said secondary battery is not higher than said first predetermined voltage.

2. A secondary battery control device according to claim 1, wherein, when said secondary battery is connected to a charger, said voltage monitoring circuit outputs an interrupt signal indicative of a request for controlling said discharge stop switch from said interrupt generation circuit to said central processing unit when the voltage of said secondary battery is not lower than a second predetermined voltage as the charge stop voltage of said secondary battery, and said central processing unit controls the cutting off of a charge current to said secondary battery.

3. A secondary battery control device according to claim 2, wherein the fact that the voltage of said secondary battery is not lower than the second predetermined voltage as the charge stop voltage of said secondary battery is detected by a charge controller which has a second predetermined voltage generation circuit for generating a second predetermined voltage as the charge stop voltage of said secondary battery and a charge stop voltage monitoring circuit for outputting a comparison result between said second predetermined voltage and the voltage of said secondary battery.

4. A secondary battery control device according to claim 3, wherein a charge stop switch for cutting off a charge current to said secondary battery and said charge controller are provided in a charger side.

5. A secondary battery control device according to claim 1, comprising means for detecting an overcurrent of said secondary battery, said overcurrent detecting means cuts off said discharge stop switch when detecting said overcurrent.

6. A secondary battery control device according to claim 1, wherein said central processing unit performs sensing control, radio communication control, and charge/discharge control.

7. A secondary battery control device according to claim 6, wherein, when said sensing control performs intermittent operation of a sensor part for performing sensing operation with said central processing unit and of a radio communication part for radio communication, a halt state of said central processing unit and generation of a control request for said discharge stop cause transition to an operational state and then performance of the charge/discharge control.

8. A secondary battery control device according to claim 6, wherein said central processing unit informs a radio base station if a state of said secondary battery inputted from said voltage monitoring circuit by radio communication before turning OFF a discharge stop switch.

9. A secondary battery control device according to claim 2, wherein said central processing unit performs sensing control, radio communication control, and charge/discharge control, and when said sensing control performs an intermittent operation of a sensor part for performing sensing operation with said central processing unit and a radio communication part for radio communication, a halt state of said central processing unit and generation of a control request for said charge stop cause transition to an operational state and then performance of the charge/discharge control.

10. A secondary battery control device according to claim 1, comprising discharge stop switches associated with a plurality of secondary batteries for controlling said plurality of secondary batteries connected in parallel, and wherein said voltage monitoring circuit compares voltages of said plurality of secondary batteries with said first predetermined voltage respectively, and when any of the voltages of the secondary batteries is not higher than said first predetermined voltage, said voltage monitoring circuit specifies any of the secondary batteries to cause an interrupt signal indicative of a request for controlling said discharge stop switch to be output from said interrupt generation circuit to said central processing unit.

11. A secondary battery control device according to claim 10, wherein the broadest plane of the secondary battery control device and the broadest plane of said plurality of secondary batteries have nearly the same shape, the secondary battery control device and said plurality of secondary batteries are connected in a stacked form, and the secondary battery control device and said plurality of secondary batteries are connected by means of positive and negative terminals provided at opposed positions along an outer edge of said plane of said secondary batteries and by means of through-pins provided at opposed positions along the other outer edge of the plane of the secondary batteries.

12. A secondary battery control device according to claim 2, wherein said charger and the secondary battery control device are magnetically connected by a primary coil provided to said charger and by a secondary coil provided to said secondary battery control device to charge the secondary battery.
